(19) United States
(12) Patent Application Publication
(10) Pub. No.: US 2009/0263259 A1
(43) Pub. Date: Oct. 22, 2009

(54) HYDRAULIC PUMP ADAPTATION FOR AN AUXILIARY POWER UNIT

(75) Inventors: Edward Patrick Picton, Reno, NV (US); Raymond English, Reno, NV (US); Richard Shaff, Reno, NV (US)

Correspondence Address: SILVERSKY GROUP LLC, 5422 LONGLEY LANE, SUITE B, RENO, NV, 89511, US

(73) Assignee: BLACK ROCK SYSTEMS LLC, Reno, NV (US)

(21) Appl. No.: 12/495,260

(22) Filed: Jun. 30, 2009

Related U.S. Application Data
(63) Continuation-in-part of application No. 11/493,495, filed on Jul. 25, 2006.

(51) Int. Cl. F04B 17/00; H02K 7/18; F02D 29/06; B60H 1/32; F25B 27/00; G06F 19/00

(52) U.S. Cl. 417/364; 290/1 A; 290/7; 290/40 D; 62/244; 62/323.1; 701/101

(57) ABSTRACT

The present invention is generally related to providing auxiliary power to long-haul trucks and similar types of transportation vehicles, and more particularly related to an easily installed and maintained auxiliary power unit that provides operational levels of electrical power and HVAC services while simultaneously driving a hydraulic system through an incorporated hydraulic pump assembly.

### CROSS-REFERENCES TO RELATED APPLICATIONS

This application is a continuation-in-part of the Cagliari et al. utility application, Ser. No. 11/493,495, filed 25 Jul. 2006, the entirety of which is hereby incorporated by reference.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BRIEF DESCRIPTION OF THE INVENTION

The present invention is generally related to providing auxiliary power to long-haul trucks and similar types of transportation vehicles, and more particularly related to an easily installed and maintained auxiliary power unit that provides operational levels of electrical power and HVAC services while simultaneously driving a hydraulic system through an incorporated hydraulic pump assembly.

### BACKGROUND OF THE INVENTION

Long-haul trucks transport goods over great distances in all parts of the world. In California alone, there are at least 180,000 transport trucks in operation. Since operators of long-haul trucks spend many days at a time on the road, the cabins for such trucks typically include a bed, as well as microwaves, air conditioners and heaters, refrigerators, televisions, stereos and other electrical appliances that require significant amounts of power. Long-haul trucks equipped with this type of cabin are referred to as sleeper berth vehicles.

In at least thirty states and the District of Columbia, many different types of vehicles, including sleeper berth vehicles, are not allowed to idle their main engines for a period longer than five minutes, which is why more of these vehicles are installing auxiliary power units (APUs) to run in place of the main engine when the drivers are attempting to sleep or making use of the other convenience features of the vehicles. While these laws are more rigorous in some states, such as California, then other states, emissions standards are becoming increasingly more rigorous nationwide.

Accordingly, a number of companies have begun to supply APUs to provide climate control and 120-volt power, to cut back on fuel consumption and air pollution, to reduce operating hours on the main vehicles engine, and to improve driver comfort and quality of life when on the road. A typical APU consumes about 0.2-0.3 gallons per hour, with significantly lower annual maintenance costs, thereby saving drivers/truck owners more than $6,900 per year in fuel costs alone. In the European Union, where long-haul trucks only idle about 1,800 hours per year, but fuel costs much more per gallon, the idle cost savings alone are over $8,500 per year.

The APUs currently on the market, however, share certain features and disadvantages. For example, most APUs use small diesel engines for power, but depending on the size of those engines, they may be able to provide only a limited amount of DC power and BTUs/hour for air conditioning and heating. Likewise, many of these engines are installed as an aftermarket addition to the trucks and are directly connected to the main engine so as to share main engine coolant, which can void warranties and prevent maintenance services from being available for the truck until the APU is removed. Some APUs do not provide for AC power because they do not include a generator, while others are noisy, cost too much to maintain, are too large or heavy, or do not provide for easy management and monitoring of the unit by the driver or the fleet owner. One of the biggest shortcomings of existing APUs is that they lack the ability to provide for concurrent power loads, meaning that drivers often have to manually shut off one electrical appliance or cooling/heating source when they want to use something else. In very cold or hot environments, this factor significantly detracts from the quality of the driver's life and therefore the attractiveness of the APU.

Hydraulic systems and machinery utilize fluid power to do the desired work. In a hydraulic system, high-pressure liquid (called hydraulic fluid) is transmitted throughout the system to various hydraulic motors and hydraulic cylinders. The hydraulic fluid is controlled directly or automatically by control valves and distributed through hoses and tubes. Hydraulic machinery is popular because of the very large amount of power that can be transferred through small tubes and flexible hoses, and the high power density and wide array of actuators that can make use of this power.

The heart of a hydraulic system is the hydraulic pump. A hydraulic pump converts mechanical energy into hydraulic energy, and is the driving force of the overall hydraulic system. Hydraulic pump output is usually measured in gallons of hydraulic fluid pumped per minute (gpm=gallons per minute). The hydraulic pump receives mechanical energy from an outside source and in response forces the hydraulic fluid through the system's various tubes, hoses, reservoirs, and/or hydraulic motors at relatively high pressure in order to do the desired work. The outside source providing mechanical energy to the hydraulic pump can be an electric motor, an engine, or even human manual power in the case of hydraulic hand pumps.

Hydraulic systems are most often used in heavy equipment, like cranes or excavators, because of the great level of force which may be generated by the pressured hydraulic fluid. Hydraulic systems are also commonly used to control the movement of various components of aircraft, such as extending and retracting landing gear, positioning flaps, operating hoists, and raising and lowering cargo doors. Hydraulic systems are used in lifting and/or transporting heavy items or cargo. Fork-lifts, order-pickers, and other jacketing equipment utilize hydraulic systems to lift or move items too heavy for human workers to lift themselves.

It would be advantageous to create an efficient APU that can drive a hydraulic system while simultaneously providing HVAC services and electrical power to a long-haul truck cabin.

### BRIEF DESCRIPTION OF THE SEVERAL VIEWS OF THE DRAWING

FIG. 1 is a perspective view of the front and left side of an APU, without the presently disclosed hydraulic pump assembly, in its service/maintenance position;

FIG. 2 illustrates an exemplary embodiment of an APU with an attached hydraulic pump assembly in accordance with the present invention;

FIG. 3 illustrates the same exemplary embodiment of an APU with an attached hydraulic pump assembly in accordance with the present invention illustrated in FIG. 2, but viewed from the side;

FIG. 4 illustrates a perspective view of the back and right side of the APU with an environmental cover and co-located condenser and fan in accordance with the present invention;

FIG. 5 illustrates a perspective view of the back and right side of the APU with the environmental cover, but without the co-located condenser and fan, in accordance with the present invention;

FIG. 6 illustrates a perspective view of the front and right side of the APU with the environmental cover and the optional step assembly, in accordance with the present invention;

FIG. 7 illustrates a perspective view of the front and right side of the frame assembly illustrating a through-the-frame rail installation, in accordance with the present invention;

FIG. 8 illustrates a perspective view of the front and right side of the frame assembly illustrating a frame rail bracket installation, in accordance with the present invention;

FIG. 9 illustrates a perspective view of the front and right side of the frame assembly illustrating an installation for pre-drilled frame rails, in accordance with the present invention;

FIG. 10 is a block diagram illustrating the interconnection between the ECU, the ECU user interface, the main engine battery, the APU engine, the cabin HVAC system, and the hydraulic pump assembly, in accordance with the present invention;

FIG. 11 is a block diagram illustrating the interaction between the APU engine, the cabin HVAC system, the hydraulic pump, and a hydraulic system, in accordance with the present invention; and

FIG. 12 illustrates a plan view of an ECU user interface in accordance with the present invention.

### DETAILED DESCRIPTION OF THE INVENTION

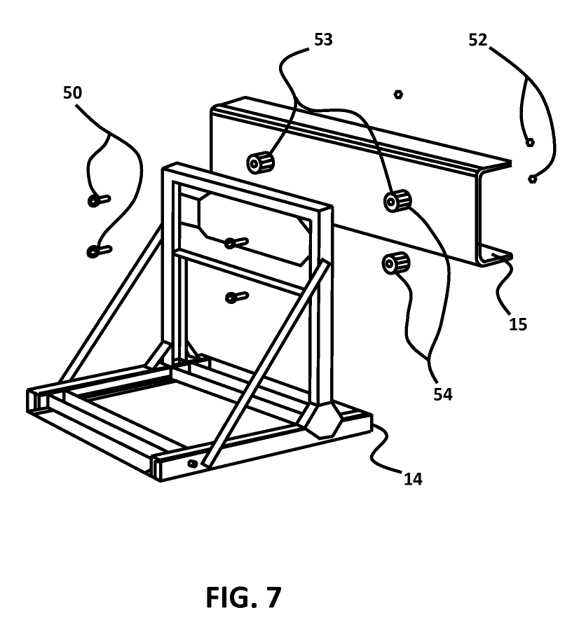

The present invention is directed towards an auxiliary power unit that includes a hydraulic pump assembly. An auxiliary power unit (or “APU”) may alternatively be referred to as an alternative power unit, or an alternate power unit. The herein disclosed APU with a hydraulic pump is capable of driving one or more hydraulic systems, such as hydraulic jacketing equipment, in addition to powering one or more truck auxiliary systems, such as driver-area services like HVAC systems and electrical power, for example. In the preferred embodiment of the present invention, the auxiliary power unit (APU) has a lateral dimension of up to approximately 62 centimeters or 24.5 inches, which is small enough to enable it to be mounted in a variety of positions behind the cabin of the truck without interfering with or taking away space from other components of the truck, although APUs of many different sizes could also be utilized in a similar fashion. Typically, the APU would be mounted close to the truck cabin on one of the two frame rails of the truck, as illustrated in FIGS. 7, 8, and 9, but the APU could also be mounted between the frame rails or to some other part of the truck.

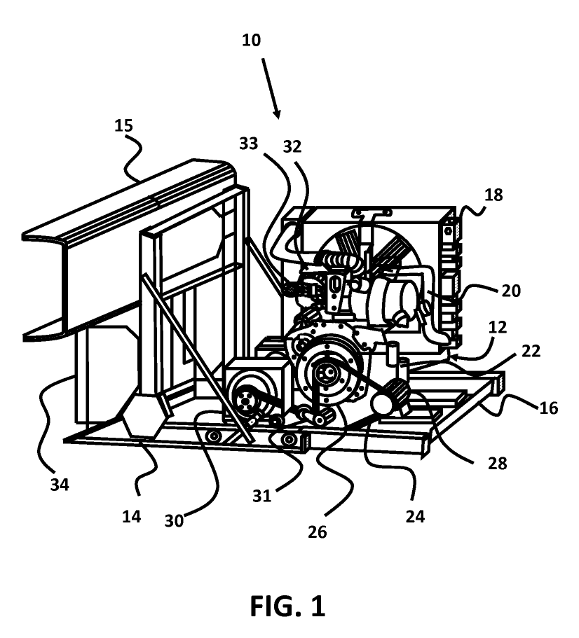

Mounting the APU to one of the frame rails provides a very stable mounting environment for the APU due to the structural integrity of the frame rails. The mounting environment also enables easier installation and access to the APU for maintenance and service. Mounting the APU close to the cabin can reduce the cost of the installation by reducing the length of the umbilical cord (described further below) between the APU and the truck cabin where the main controller for the APU is located. Such placement considerations must be balanced against the potential benefits of locating the APU with a hydraulic pump physically closer to the hydraulic system. For example, if the APU will be utilized to drive hydraulic lifting equipment located in the trailer of the truck, near the goods being hauled, then there may be efficiency losses associated with placing the APU, and the attached hydraulic pump, further away from the trailer. In the preferred embodiment of the present invention, a frame rail mounted APU is disclosed that facilitates access for maintenance and service, as further illustrated in FIGS. 1 and FIGS. 4-9.

FIG. 1 is a perspective view of the front and left side of APU 10 when viewed facing the side of the truck to which the APU 10 is mounted. APU 10 illustrated in FIG. 1 does not show the hydraulic pump assembly. The APU 10 includes the APU engine 12, which is a two or three cylinder diesel engine mounted to a frame assembly 14, which includes a sliding component 16. The frame assembly 14 is attached to the frame rail 15 of the truck, but the sliding component 16 enables the entire diesel engine 12 to be pulled away from the truck and easily accessed by anyone needing to service the engine, the hydraulic pump, or any other component of the herein described APU.

As noted, FIG. 1 illustrates the APU engine 12 without the hydraulic pump assembly, when the sliding component 16 has been pulled away from the frame assembly 14, such as when it is being serviced. In order for the engine 12 to be pulled away from the truck on the sliding component 16, certain mechanical and electrical components need to be designed to facilitate this type of movement without breaking down over a number of years. For example, the electrical wiring between the APU 10 and the truck cabin is provided through a spring-shaped umbilical cord consisting of power wires and communication wires. The spring shape of the cord enables it to stretch out when the APU is pulled away from the truck for service, and to shrink back into a smaller size when the APU is in its normal operating position, all without putting undue stress on the wires within the cord. Likewise, the exhaust pipe is connected with a flexible metal hose and a quick-fit connector, rather than welded in place. Additionally, any hydraulic fluid tubes and/or hoses that connect the hydraulic pump assembly (not shown in FIG. 1) to a hydraulic system, such as a lifting system located in the truck's trailer for example, must be flexible and capable of withstanding the repeated stretching and straining associated with pulling the overall APU away from the truck frame during servicing and pushing the overall APU back into the normal operating position.

As noted, the APU engine 12 is typically a two or three cylinder diesel engine capable of generating approximately 10-30 horsepower at varying revolutions per minute, such as the YANMAR TNV SERIES engines, although other types and sizes of engines could be utilized. A diesel engine of the indicated power is preferred due to environmental concerns (reduced emissions and noise), economics (better fuel economy while providing more than adequate power) and driver convenience (most long-haul trucks utilize diesel engines, thereby allowing the main engine and the APU to be fueled at the same time). Such a diesel engine also allows for full driver area functionality (HVAC and 110 volt electrical power) while simultaneously driving the hydraulic pump at up to 95% efficiency. Most truck owner/operators prefer to link the APU to the main gas tank(s) for the truck, rather than carry an additional tank for the APU, so using common fuel under such circumstances is essential. It would be preferable, obviously, to provide a separate storage tank for the APU, if the APU engine 12 used a fuel that could not be used by the main truck engine, although this would add significantly to the cost of installing the APU.

As illustrated in FIG. 1, some of the major visible components of the APU engine 12 include a water/coolant radiator 18, an air cleaner 20, and fuel filters 22 on the right-hand side of the engine. At the front of the APU engine 12, driven by the serpentine belt 24 are the engine flywheel 26, the air conditioning compressor 28, the AC power generator 30, and the belt tensioner 31. The DC power alternator 32 is shown on the back left-hand side of the engine 12, as is the exhaust pipe 33.

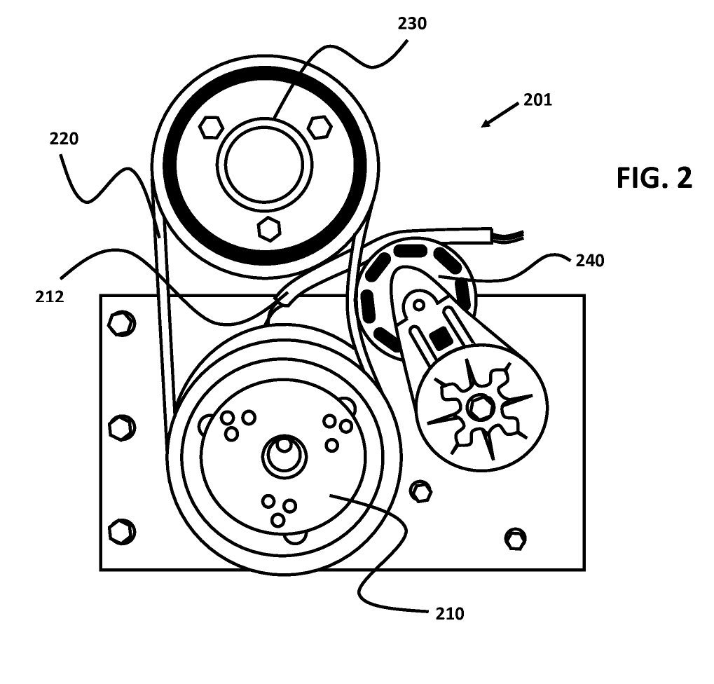

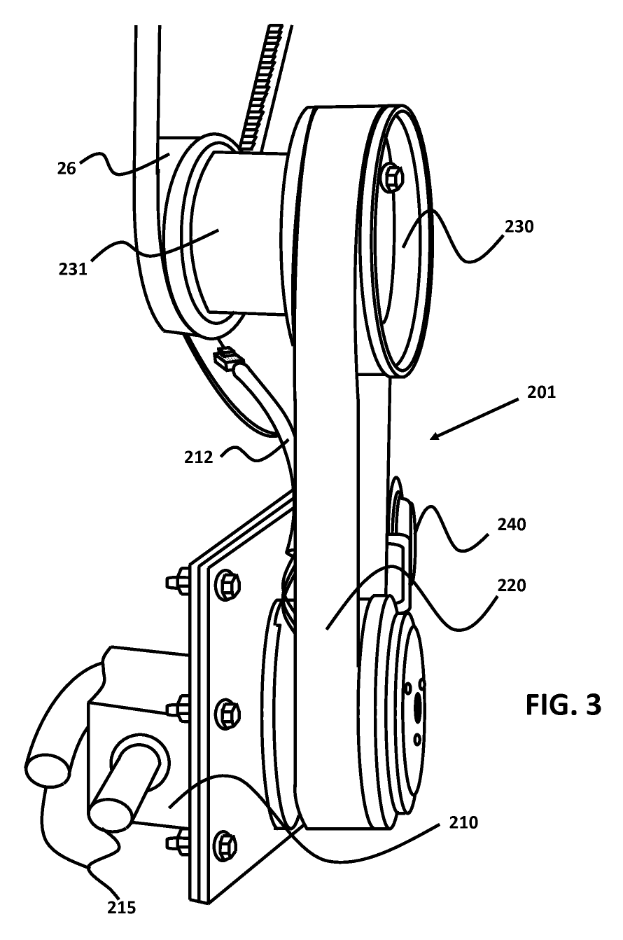

A hydraulic pump assembly may be functionally attached to the flywheel 26 shown in FIG. 1, or to crankshaft driven components such as a pulley, creating an APU capable of driving a hydraulic system. FIGS. 2 and 3 illustrate one example of such a configuration. As illustrated in FIG. 2, hydraulic pump assembly 201 may be attached on the front side of engine flywheel 26 (which is not visible in FIG. 2 because it is obscured by the presence of the hydraulic assembly pulley 230 in FIG. 2). Hydraulic assembly pulley 230 may be attached directly onto the face of engine flywheel 26, as will be apparent to those skilled in the art. Hydraulic assembly belt 220 runs from hydraulic assembly pulley 230 down towards hydraulic pump 210, which may be bolted onto the lower left portion of APU 10 as positioned in FIG. 1. Hydraulic assembly belt tensioner 240 may be utilized to optimize the tension of hydraulic assembly belt 220, as is known in the art. Hydraulic pump electrical control leads 212 may be run from hydraulic pump 210 to the engine control unit (ECU), which may be utilized to control operation of the hydraulic pump. The engine control unit will be discussed in further detail below. Those skilled in the art will recognize that is possible to achieve substantially similar results by running the hydraulic pump assembly 201 off the back side of the engine, by functionally attaching hydraulic pump 210 to a pulley which itself is functionally attached to the engine's crankshaft.

FIG. 3 illustrates a perspective view of the same hydraulic pump assembly illustrated in FIG. 2. Hydraulic assembly pulley 230 is attached to engine flywheel 26 by extender 231. As described above, the hydraulic pump assembly may alternatively be mechanically attached to, and driven by, a pulley attached to the engine's crankshaft (not shown in the figures). Hydraulic assembly belt 220 runs from hydraulic assembly pulley 230 down to hydraulic pump 210, which may be bolted to the frame of the APU, somewhat below engine flywheel 26. Hydraulic pump inlet and outlet ports 215 are also illustrated protruding from hydraulic pump 210 in FIG. 3. Inlet and outlet ports 215 may be connected via hydraulic fluid tubes or hoses to the rest of the hydraulic system (not shown in FIG. 3).

Any sort of suitable hydraulic pump may be utilized as hydraulic pump 210, and an optimum hydraulic pump choice mostly depends upon the hydraulic system that hydraulic pump assembly 201 is going to be driving. For example, hydraulic lifting equipment used to lift or move goods at the back of a long-haul truck may properly utilize a 5.5 gpm hydraulic pump or a 7 gpm hydraulic pump at 210 of hydraulic pump assembly 201. A 5.5 gpm hydraulic pump is preferred for use in combination with a 2-cylinder APU engine 12, producing an APU capable of providing HVAC services (operating/powering an air conditioning compressor and a coolant-based radiator) and electrical power (operating/powering a DC power alternator and an AC power generator) to the truck cabin (the driver-area of the vehicle, which may alternatively be referred to as the human occupied area of the truck) while simultaneously driving the hydraulic pump at 95% efficiency. Additionally, it may be possible to incorporate hydraulic energy storage technology, well known in the art, to the herein disclosed hydraulic pump assembly for an APU in order to operate at higher levels of hydraulic fluid flow (thereby producing more hydraulic power) while utilizing the same 5.5 or 7 gpm hydraulic pump at hydraulic pump 210.

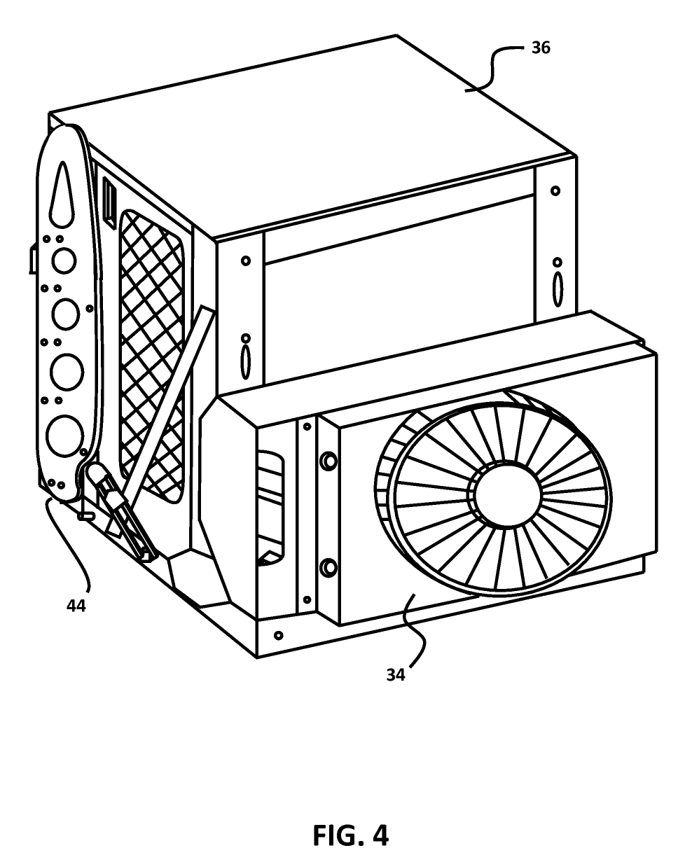

As further illustrated in FIG. 1, the backside of the air conditioning condenser and fan 34 is shown. A perspective view of the front and right side of the condenser and fan 34 is illustrated in FIG. 4. The condenser and fan 34 need not be co-located with the engine 12, if space in the area of the APU installation is at a premium, or if the owner/operator prefers to move the condenser and fan 34 as far away from the truck cabin as possible so as to reduce noise inside the cabin.

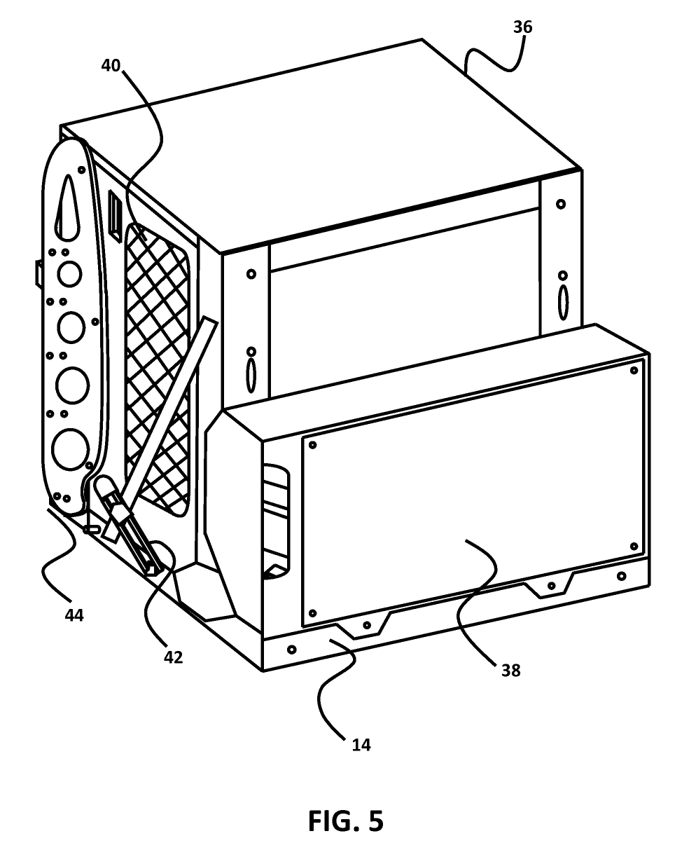

In such cases, as illustrated in FIG. 5, the condenser and fan could be removed from the frame assembly 14, with the resulting opening being covered by the plate 38. The coolant lines from the compressor 28 would then be run to wherever the condenser and fan had been relocated in order for the air conditioning system to operate property. The condenser and fan 34 works in conjunction with the compressor 28 to provide approximately 26,000 BTU/hr of air conditioning for the cabin of the truck when the APU 10 is being utilized in place of the truck's main engine. The generator 30 is configured to provide between 3.7 Kw to 6.0 Kw of AC power, while the alternator 32 is configured to provide approximately 55 Amps of DC power, although different levels of cooling and power could be configured. APU 10 will continue to provide similar levels of heating, cooling, and electrical power while simultaneously driving hydraulic pump assembly 201 via engine flywheel 26 (or via the engine's crankshaft).

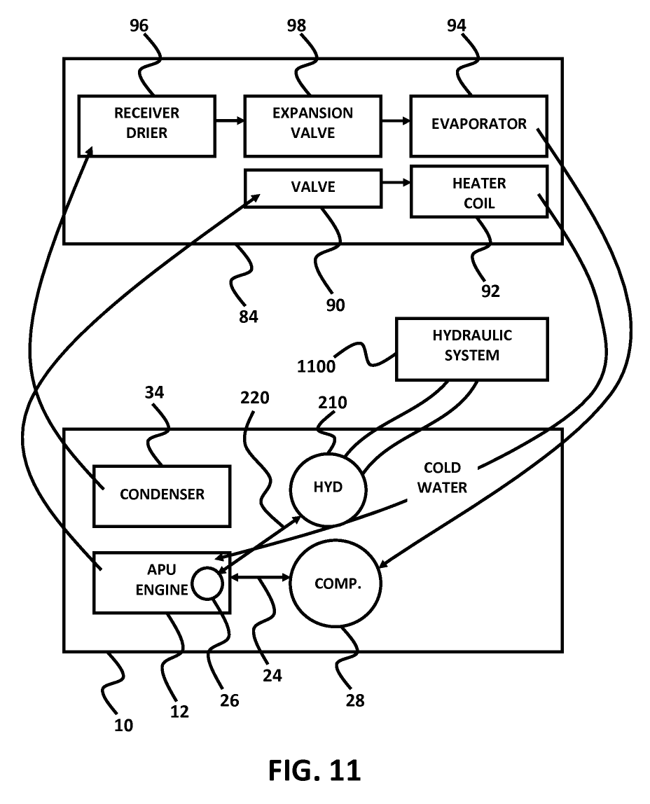

In the preferred embodiment of the invention, the cabin is also provided with approximately 26,000 Btu/hr of heat through use of heating coolant from the radiator and a heater core. Heat from the engine 12, for starting and running in cold climates, is provided by a block heater. In FIG. 11, the interaction between the APU engine, the cabin HVAC system, and a hydraulic system will be further described. Also, as further described below with respect to the ECU, the air conditioning and heating system (HVAC) and a hydraulic system can be automatically or manually controlled.

FIGS. 4 and 5 also illustrate the APU 10 covered by its environmental shell 36 (but without the hydraulic pump assembly 201), which further reduces the level of noise produced by the APU engine 12. FIGS. 4 and 5 show the APU 10 as positioned in its normal operating position. The environmental shell 36 provides protection to the APU engine 12 when the truck is on the road, while allowing sufficient air to move through the shell, such as through screen 40. A variety of different shells could be used depending on the owner of the truck and the location of the APU 10. Owner operated trucks that have the APU 10 installed in a visible location may want a visually appealing cover, such as diamond plate metal or chromed metal. When the APU 10 is not visible, or the owner of the truck is less concerned with appearance, a less expensive thermoplastic (or similar type of material) could be used. Of course, when the hydraulic pump assembly is attached to APU engine 12, the environmental shell 36 may need to be slightly enlarged in order to accommodate the additional components, such as the hydraulic assembly pulley 230, hydraulic assembly belt 220, hydraulic belt tensioner 240, hydraulic pump 210, or inlet and outlet ports 215, which may protrude out further from the APU engine 12 than can be accommodated with the standard environmental shell 36.

As previously noted, sliding component 16 of the frame assembly 14 enables the entire APU engine 12 to slide out from its operating position on the rollers of the sliding component 16 when it is necessary to maintain and service the APU 10. To prevent the APU engine 12 from sliding out during operation, the sliding component and engine need to be locked into position, using bolts or some similar form of fixation. The bolt heads should preferably be located at the front of the APU so they can be easily accessed and removed when maintenance or service is required. The environmental shell 36 could also be bolted down, or the tie downs 42 on either side of the shell, connecting the frame assembly 14 to the environmental shell 36, could be utilized to provide a quick release mechanism for the shell.

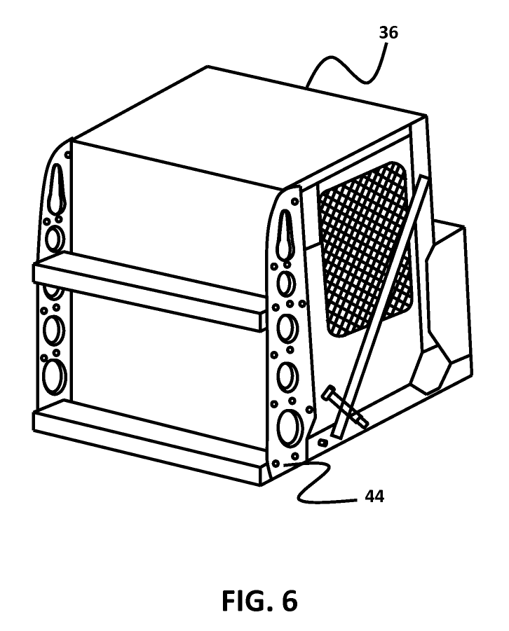

FIGS. 4 and 5 further illustrate a step assembly 44 that could be affixed to the APU 10, which is better illustrated in FIG. 6. The step assembly is optional, but when provided, enables someone to climb the steps on the APU 10 to get on top of the APU 10 or the upper portion of the truck. FIG. 6 does not show the herein disclosed hydraulic pump assembly 201, but when a hydraulic pump assembly is utilized, step assembly 44 may also have to be modified to accommodate inlet and outlet ports 215 or other hydraulic pump assembly components.

As previously noted, in the preferred embodiment of the present invention, the APU 10 is mounted to the frame rail 15 of the truck. FIGS. 7, 8, and 9 illustrate three ways in which such mounting is achieved. In FIG. 7, the frame assembly 14 is affixed to the frame rail 15 by a series of bolts 50 and nuts 52. The bolts 50 are inserted into holes 53 that have to be drilled through the frame rail 15 for the purpose of mounting the APU 10. In some applications, it may be desirable to distance the frame assembly 14 from the frame rail, for example to provide extra space for the condenser and fan 34 when that item is mounted to the APU 10 instead of in a remote location, or to provide space necessary for inlet and outlet ports 215 of hydraulic assembly 201. In such cases, different length spacers 54 could be utilized between the bolts 50 and nuts 52. When utilizing spacers 54 to create additional space for the APU 10, caution must be exercised to prevent the APU 10 from extending too far away from the side of the truck, lest it collide with another object when the truck passes by the object.

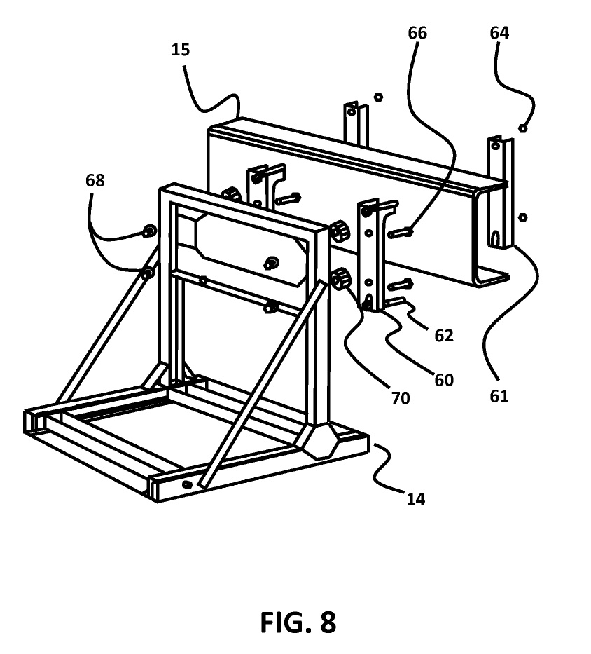

Some truck owners object to drilling holes in the frame rails out of concern for the structural integrity of the rails or due to a general unwillingness to make any permanent alterations to the truck's body. For fleet operators, business arrangements regarding the ownership and/or financing of the trucks can lead to long delays and special permissions being required in order to drill holes in the frame rails. In such cases, the bracket arrangement illustrated in FIG. 8 can be utilized. As shown in FIG. 8, a front bracket 60 is attached to a rear bracket 61, with the frame rail 15 situated in-between the brackets, by bolts 62 and nuts 64. The frame assembly 14 is then affixed to the front bracket 60 by the bolts 66 and the nuts 68. As discussed in FIG. 7, spacers 70 could also be utilized to provide extra space for the APU 10. A wide variety of different means of attaching the frame assembly 14 to the frame rails 15 or the truck could also be utilized.

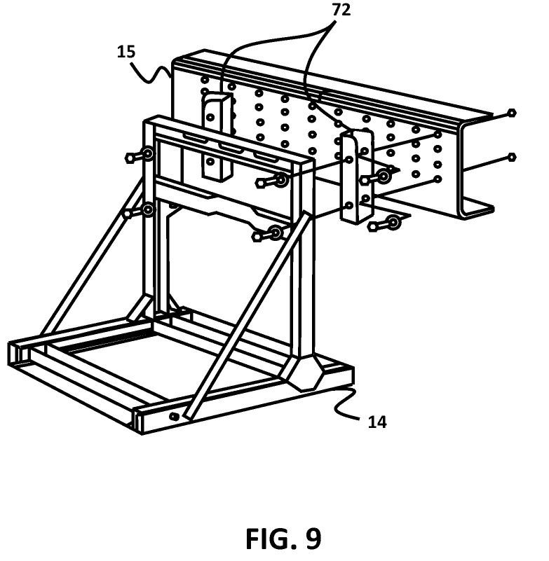

In many European countries, the frame rail 15 of the truck is pre-drilled with holes for a number of different reasons, including mounting accessory equipment such as an APU. FIG. 9 illustrates an example of a pre-drilled frame rail 15, where the pre-drilled holes do not necessarily line up with the mounting components of the frame assembly 14. In such a case, conversion brackets 72 would be utilized to form an interface between frame assembly 14 and the frame rail 15. For example, the frame assembly 14 would be bolted to one side of bracket 72, with holes in that one side of the bracket designed to line up with holes in the frame assembly 14, while the other side of bracket 72 would be bolted to the frame rail 15, with holes in that other side of the bracket designed to line up with holes in the frame rail 15.

The APU 10, the hydraulic pump assembly 201, and other aspects of the invention are controlled by an engine control unit (ECU) or engine management system (EMS), which is a microprocessor controlled electronic device that enables programmed or external control of the APU engine 12 and other electronically controlled components. ECUs are commonly used to control vehicle engines and are well known in the art. The ECU includes a variety of electrical components on a printed circuit board, including the aforementioned microprocessor that processes inputs from the engine and hydraulic pump assembly sensors in real time and controls the hardware (including all of the electro-mechanical components of the APU, including the in-cabin HVAC system and the hydraulic pump) in accordance with operator inputs and/or programmed instructions in the form of software or firmware. The typical ECU of an engine can read many different sensors associated with the engine and use that information to control various aspects of the engine's operation. This might include the ignition systems of the engine so as to improve fuel efficiency, regulate power, and lower pollution levels. The ECU can also compensate for many engine operation variables, such as ambient temperature, humidity, altitude, and fuel octane ratings.

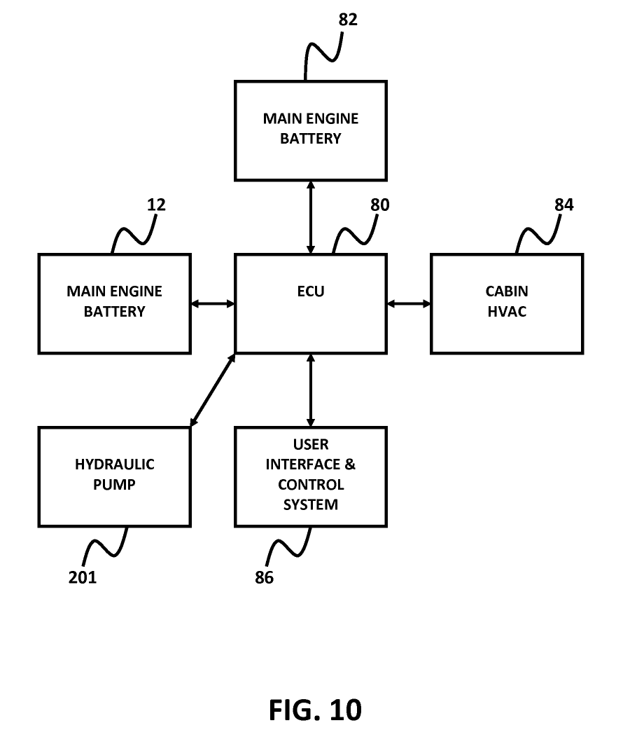

As shown in FIG. 10, with respect to the present invention, the ECU 80 is utilized to control various operational aspects of the APU engine 12, as well as the main engine battery 82 of the truck, the truck's in-cabin HVAC system 84 associated with the APU, and the hydraulic pump assembly 201. The ECU 80 is in turn partly or fully controlled by the ECU user interface and control system 86. Preferably, the ECU user interface and control system 86 is multifunctional, depending on who is using it and how the various interfaces to the control system 86 are provided. For example, the control system 86 can have an electro-mechanical user interface in the cabin of the truck that can be accessed by the driver of the truck. Alternatively, control system 86 can have a separate or an additional electro-mechanical user interface located back in the trailer portion of the truck, close in proximity to a hydraulic lifting system and the goods that need to be lifted. It may also be advantageous to separate the user interface and control system 86 into two user interfaces, one located in the cabin for the driver to control in-cabin HVAC system 84 and other cabin area services (a cabin user interface) and one located in the trailer for controlling a hydraulic lifting system (a hydraulic system user interface).

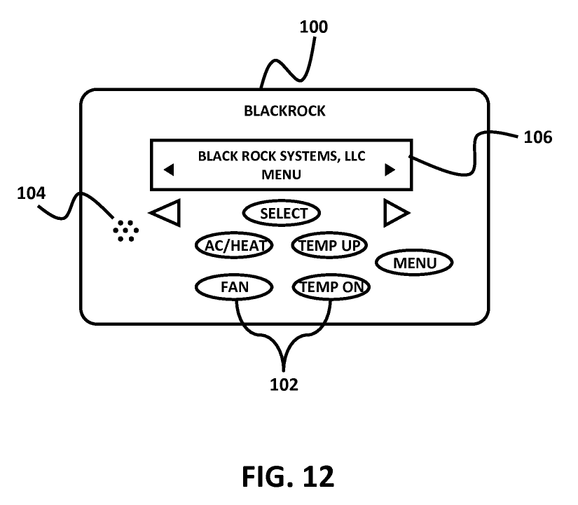

This type of user interface for the control system 86 utilizes a simple visual display or electrical touch screen and/or a series of basic tact switches that allow the truck driver to control some basic functions of the APU 10 through the ECU 80. An example of a user interface with an alphanumeric display and tact switches is further illustrated in FIG. 12. Since many truck drivers are older and less comfortable with electronic interfaces than many younger drives, they may prefer toggle switches, rotary switches and encoders, which are the switches typically utilized in modern automobiles and trucks used to control radios and heating/cooling systems.

In addition to the electro-mechanical user interface, one or more additional types of interfaces, such as a USB interface, are preferably provided, with any and all types of user interfaces being referred to herein as a user interface unless otherwise states. The advantage of the USB interface is that it will enable direct and remote connection of a computer to the ECU 80. A directly connected computer could be utilized when performing maintenance and service on the truck, or when first installed or upgrading the APU 10. Remote computer connections, for example, through a wireless Ethernet connection to the ECU 80, would provide long-range remote diagnosis and maintenance on the APU 10, as well as computerize setup, upgrade, testing and diagnosis of the APU 10. Additional wireless connections could be provided through an Internet connection, a Bluetooth connection or even through a cell phone network. Drivers could even be provided with some sort of wireless remote control device, like for a television set, which would enable them to perform simple operations while sitting in a dinner near their truck.

While the driver's user interface might be structured to only allow the driver to control some very basic operations, such as turning the APU on and off, setting the temperature for the air conditioning or heating within the truck cabin, turning a fan on or off, turning the hydraulic pump on or off and adjusting hydraulic fluid flow, and perhaps checking on certain basic maintenance items, such as whether the APU is in need of oil, computer-based user interfaces could provide a broader range of control options. Irrespectively of the control means, all such control devices would perform certain similar functions, such as setting operating times and conditions, and providing input/output data associated with usage, service and support information.

The broader range of access and control provided by remote computers enables some unique features associated with the APU. For example, a different level of access could be provided to a truck owner (other than the driver) or to a fleet operator, thereby enabling the owner/operator to monitor the truck, the APU 10 and to control both to some degree. The owner/operator could limit the high or low temperatures that could be selected by the driver, or the amount of time the APU is allowed to run, or perform system checks to make sure the APU is not in need of service or maintenance. The owner/operator could similarly limit use of the attached hydraulic pump assembly. Likewise, the owner/operator could set certain controls that could not be overridden by the driver (or only overridden in case of emergency with the proper code), such as when the APU is turned on. For example, some drivers many not want to use the APU, preferring instead to idle the main truck engine, but the owner/operator might want the APU used instead to save money and to cut down on the operating time of the main truck engine. In some fleet trucks, the owner/operator may even prefer to prevent the driver from having any control over the APU through a user interface at all, leaving all such control for preprogrammed operation or remote control by the fleet operator.

The driver/owner/operator could program the APU to turn on and off at scheduled times, such as turning the APU on for one hour every morning when the truck is not in use. In other cases, the owner/operator could use the programming of the APU to control the driver's utilization of the APU and associated cabin-area services such as HVAC and electrical power. For example, the owner/operator could set the APU user interface 86 to turn the APU 10 on after the truck has idled for more than five minutes, to see whether the main truck engine is still running, and if necessary to turn off the main truck engine. Providing a wiring connection to the ignition of the truck and the truck's main battery would readily enable this function. Monitoring the battery would tell the owner/operator whether the main truck engine was still running, thereby enabling the owner/operator to remotely kill and disable the ignition of the truck.

The control system 86 would also preferably include a real time clock that would enable timed runs of the APU, the current time to be displayed on the display 106, the APU engine hours to be tracked for maintenance purposes, and for time-stamped logs to be created. The time-stamped logs could be used to log events such as failures, warnings, run time intervals, telemetry, etc. The control system 86 would also preferably include a means of connecting the J1939 bus that is common to most modern tractor/trailer trucks. This bus controls various sub-systems within the truck and could be used by the APU 10 to likewise interface with and control these same systems, such as the running of the main truck engine, the recharging of the battery, etc. As previously noted, the APU 10 could receive power from a battery, such as the main truck engine battery or a separate battery just for the APU 10. Likewise, a backup battery could be provided within the control system 86 box to keep the ECU and the clock running even when power is lost from the other batteries on the truck.

As previously noted, remote control of the control system 86 would also enable the owner/operator to perform less nefarious activities, such as monitor oil and coolant levels, monitor hydraulic pump use or performance, perform other diagnostics, perform remote upgrades and maintenance, etc., or to even communicate with the truck driver through the in-truck user interface. Diagnostics provided by the ECU would include various fault codes that correspond to typical engine faults that can either be stored in a log when they occur or remotely transmitted to a central control facility while the truck is on the road. Usage patterns could also be recorded or transmitted to enable fleet operators to facilitate budgeting and planning, or to prevent overuse or abuse. Any of these different levels of control would be associated with different levels of access, such as through a user name and password, such that the driver would have one level of access and control, the operator a second level of access and control, the owner a third level, and the manufacturer or service provider for the APU a fourth level.

To better explain the temperature control features of the APU, reference is now made to FIG. 11, where the cabin HVAC system 84 is explained in detail. The cabin HVAC system 84 is part of the APU 10 and is located within or in close proximity to the cabin of the truck so that it can efficiently transfer hot and cold air into the cabin as required. It is important to note that the APU 10 of the present invention is “passive” to both the main engine of the truck and to the HVAC system associated with that main engine. In other words, the APU 10 (including the HVAC system) does not rely upon any major subsystem or component of the main truck for operation, such as the coolant, refrigerant and oil lines, the HVAC system, the electrical system, etc. The APU 10 can be configured to connect to the truck's electrical system to provide back-up power and recharge of the truck's battery or to kill the truck's engine, but the APU 10 does not rely upon any such connection for its own operation.

To provide heat to the cabin of the truck, hot water is routed out of the radiator of the APU engine 12 to an electro-mechanical valve 90 within the cabin HVAC system 84 and then to a heater coil 92. A blower fan, not shown in FIG. 11, blows air through the heater coil and into the cabin of the truck to provide heat. Control of heat within the truck is controlled by the valve 90, which is in turn controlled by the user interface and control system 86. When a higher temperature is selected by the driver (or remotely) using the control system 86, the valve 90 is opened further. Likewise, when a lower temperature is desired, the valve 90 may be further closed, or the fan speed could be lowered.

In extremely cold climates, such as Alaska, parts of the United States, Canada and Europe, an additional heating feature might be required to warm the engine. Inserting an electric heater inside the radiator coolant hose of the APU engine 12 provides this feature. Providing power to the electric heater heats the coolant within the hose and makes it easier for the engine of the APU to start in cold weather.

The cabin HVAC system 84 provides air conditioning within the cabin of the truck in a similar fashion. The APU engine 12 drives the engine flywheel 26, which is connected to the air conditioning compressor 28 by the serpentine belt 24. The air conditioning compressor, which is basically a pump, is responsible for compressing and transferring refrigerant gas to the condenser 34. The intake or suction side of the compressor 28 draws refrigerant gas from the outlet of the evaporator 94, further explained below. That refrigerant gas is then compressed and sent to the condenser 34, where it can transfer the heat that is absorbed from the inside of the vehicle.

The condenser 34 is like a radiator. It is designed to radiate heat. As previously noted, it can be located in a variety of different locations relative to the APU engine 12 so as to improve air flow through the condenser 34 and to reduce noise from the condenser fan near the cabin of the truck. As hot compressed gasses are introduced into the condenser 34, they are cooled off. As the gas cools, it condenses and exits the condenser 34 as a high-pressure liquid. This high-pressure liquid is then routed to the receiver-drier 96, which is designed to separate gas and liquid and to remove moisture and filter out dirt from the refrigerant. The refrigerant is routed from the receiver-drier 96 to the electro-mechanical expansion valve 98, which can sense both temperature and pressure and can therefore be used to regulate the flow of refrigerant to the evaporator 94. Hence, to control the air conditioning within the cabin of the truck, the ECU 80 regulates the operation of the compressor 28 and the fan (not shown) through the controls specified by the user interface and control system 86.

The evaporator 94 serves as the heat absorption component of the cabin HVAC system 84. Its primary duty is to remove heat from inside the cabin and to dehumidify the air inside the cabin. As warm air is sucked out of the cabin by the fan (not shown), it travels through the aluminum fins of the cooler evaporator coil, the moisture contained in the air condenses on its surface. And, as refrigerant enters the evaporator and warm air passes through the evaporator fins, the refrigerant boils, causing it to absorb large amounts of heat, which is then carried off with the refrigerant to air conditioning compressor 28. As the heat is absorbed from the air blowing through the evaporator that air is cooled and in return blown back into the cabin of the truck.

At the same time that engine flywheel 26 is driving compressor 28 via serpentine belt 24, engine flywheel 26 is also driving hydraulic pump 210 via hydraulic assembly belt 220. As described above, the hydraulic pump assembly 201 is a part of the overall APU 10. Hydraulic pump 210 provides hydraulic pressure to a hydraulic fluid, thereby forcing the hydraulic fluid out through inlet port 215 (not shown in FIG. 11) to hydraulic system 1100, which as explained above may be a hydraulic lifting system located in the truck's trailer and used for lifting/moving the goods being shipped, such as automobiles on a car hauler. The hydraulic fluid may return from hydraulic system 1100 and re-enter hydraulic pump 210 via outlet port 215 (not shown in FIG. 11). Alternatively, hydraulic pump 210 may be mechanically coupled to the engine's crankshaft (not shown in the Figures). For example, hydraulic pump 210 can be driven via a belt functionally attached to a pulley that is itself attached to the crankshaft.

As previously noted, the ECU 80 is controlled through operation of the user interface and control system 86. FIG. 12 illustrates an example of an in-truck user interface 100. So as to reduce environmental stress and in order to consolidate the location of the various aspects of the control system 86 and the ECU 80, these two components would be preferably collocated, and referred to herein collectively as the control system 86, within the cabin of the truck in a chassis of some type. The control system 86 would be contained within a plastic or metal box that would be mounted in a convenient location somewhere within the cabin of the truck, and connected to the APU engine 12, the cabin HVAC 84, the hydraulic pump 210, and the other components of the APU 10 through various wires, although wireless interconnections could also be utilized. The ECU could also be mounted within a separate box somewhere within the cabin and inaccessible to the driver.

Within either the ECU box or the control system box, would be the microprocessor or controller of the ECU that would interface to the user interface 100. This user interface would preferably be mounted to the front of one of the boxes within the cabin and be comprised of a series of buttons 102, a speaker 104 and a display panel 106. The buttons 102 enable the user to scroll through a series of displayed instructions or results and to make necessary selections. The buttons 102 also enable the user to start and stop the APU engine 12, select air conditioning or heating, control a fan, turn the temperature in the cabin up or down, turn the hydraulic pump on or off and adjust the hydraulic fluid flow to and from the pump, and access a main menu system on the display 106. As previously noted, many different types of controls can be utilized in place of buttons, such as dials, knobs, and a wide variety of switches. As shown in FIG. 10, the buttons 102 are tact switches that provide a small amount of tactile feedback to the user when operated. Additional feedback could be provided in the form of some tone or audible message to the user to indicate that a button 102 has been fully depressed when making a selection. This tone would be routed through the speaker 104.

One of the buttons 102 on the user interface 100 is the start/stop button, which is used to turn the APU engine 12 on and off. When the APU is not running and the start/stop button is selected, the APU engine 12 will be started, and vice versa, when the button is selected when the APU engine 12 is running, then the APU engine will be stopped. However, before the APU engine can be started or stopped through control of the user interface 100, the ECU needs to be running. Normally, the ECU is booted up when power is provided to the APU system, such as through a battery or through the truck's electrical system.

While the present invention has been illustrated and described herein in terms of a preferred embodiment and several alternatives, it is to be understood that the techniques described herein can have a multitude of additional uses and applications. Accordingly, the invention should not be limited to just the particular description and various drawing figures contained in this specification that merely illustrate a preferred embodiment and application of the principles of the invention.

What is claimed is:

1. An alternative power unit mounted to a vehicle for use in place of a main engine of the vehicle, comprising:
an engine having sufficient power to concurrently operate a DC power alternator, an AC power generator, an air conditioning compressor, and a coolant-based radiator;
a hydraulic pump assembly coupled to the engine providing hydraulic pressure to a hydraulic fluid to operate a hydraulic system associated with the vehicle;
a frame for mounting the engine to the vehicle;
a HVAC system within a human occupied area of the vehicle coupled to the air conditioning compressor and the coolant-based radiator;
an engine control unit having a programmable processor coupled to the engine, the hydraulic pump assembly, and the HVAC system; and
a user interface controlling the engine control unit.

2. The alternative power unit as recited in claim 1, wherein the engine further includes a condenser and fan unit that can be mounted to the frame or mounted to a portion of the vehicle remote from the human occupied area.

3. The alternative power unit as recited in claim 1, wherein the engine further has sufficient power to concurrently operate the hydraulic pump assembly while operating the air conditioning compressor and the coolant-based radiator.

4. The alternative power unit as recited in claim 1, wherein the engine and hydraulic pump assembly are covered by a detachable environmental shell.

5. The alternative power unit as recited in claim 1, wherein the user interface is located in a trailer of the vehicle.

6. The alternative power unit as recited in claim 1, wherein the user interface is located outside of the human occupied area of the vehicle.

7. The alternative power unit as recited in claim 1, wherein the user interface is separated into a cabin user interface located in the human occupied area of the vehicle and a hydraulic system user interface located outside of the human occupied area of the vehicle or in a trailer of the vehicle.

8. The alternative power unit as recited in claim 1, wherein the user interface includes a computer interface for direct or remote connection of a computer to the engine control unit for operation, control, monitoring, or modification of the engine control unit.

9. The alternative power unit as recited in claim 1, wherein the user interface includes a wireless connection for remote connection of a computer to the engine control unit for operation, control, monitoring, or modification of the engine control unit.

10. The alternative power unit as recited in claim 1, wherein the engine control unit provides different levels of user control.

11. The alternative power unit as recited in claim 10, wherein the different levels of user control correlate with different levels of access, through different user names and passwords, to the engine control unit such that a vehicle driver, an operator, an owner, a manufacturer or a service provider each have a desired level of access.

12. The alternative power unit as recited in claim 1, wherein the engine control unit terminates power to the main engine after the main engine has idled for a predetermined period of time and activates the engine.

13. The alternative power unit as recited in claim 1, wherein the engine control unit includes a real time clock for displaying a time on the user interface and operating in conjunction with the engine control unit to create a time stamped log and track usage of the hydraulic pump assembly.

14. The alternative power unit as recited in claim 1, wherein the engine further includes an engine flywheel, and wherein the hydraulic pump assembly includes a hydraulic pump, a hydraulic assembly pulley functionally attached to the engine flywheel, and a hydraulic assembly belt attached to the hydraulic assembly pulley transferring power to the hydraulic pump to provide hydraulic pressure to the hydraulic fluid.

15. The alternative power unit as recited in claim 14, wherein the hydraulic pump is a 5.5 gpm hydraulic pump.

16. The alternative power unit as recited in claim 14, wherein the hydraulic pump is a 7 gpm hydraulic pump.

17. An alternative power unit for use in place of a main engine of a vehicle, providing one or more driver-area services, and driving a hydraulic system, comprising:
an engine providing power for the one or more driver-area services;
a hydraulic pump assembly;
an engine control unit having a programmable processor coupled to the engine and the hydraulic pump assembly; and
a user interface controlling the engine control unit.

18. The alternative power unit as recited in claim 17, wherein the engine further includes an engine flywheel, and wherein the hydraulic pump assembly includes a hydraulic pump, a hydraulic assembly pulley functionally attached to the engine flywheel, and a hydraulic assembly belt attached to the hydraulic assembly pulley transferring power to the hydraulic pump to provide hydraulic pressure to a hydraulic fluid in the hydraulic pump.

19. The alternative power unit as recited in claim 17, wherein the engine control unit controls operation of the hydraulic pump.

20. The alternative power unit as recited in claim 17, wherein the engine control unit controls operation of the hydraulic pump and the engine so as to control the one or more driver-area services.

21. The alternative power unit as recited in claim 20, wherein the one or more driver-area services includes HVAC service.

22. The alternative power unit as recited in claim 20, wherein the one or more driver-area services includes electrical power.

23. The alternative power unit as recited in claim 17, wherein the vehicle is a car hauler and wherein the hydraulic pump assembly operates a trailer portion of the car hauler.

24. The alternative power unit as recited in claim 23, wherein the user interface is located in the trailer portion.

25. The alternative power unit as recited in claim 23, wherein the user interface is located outside of a human occupied area of the vehicle.

26. The alternative power unit as recited in claim 23, wherein the user interface is separated into a cabin user interface located in a human occupied area of the vehicle and a hydraulic system user interface located outside of a human occupied area of the vehicle or in the trailer portion.
